(19) United States
(12) Patent Application Publication
(10) Pub. No.: US 2015/0066705 A1
(43) Pub. Date: Mar. 5, 2015

(54) ELECTRONIC SEARCH ENGINE WITH ENHANCED FUNCTIONALITIES OF GENERATING VISUAL-ONLY PRODUCT/SERVICE-RELEVANT SEARCH RESULTS CONFIGURED FOR DELIVERY OF PRODUCT/SERVICE- RELEVANT INFORMATION UPON SELECTION THEREOF, AND MOBILE SMART DEVICES AND METHODS OF UTILIZING THEREOF ONLINE

(71) Applicant: David E. White, Boca Raton, FL (US)

(72) Inventor: David E. White, Boca Raton, FL (US)

(21) Appl. No.: 14/478,555

(22) Filed: Sep. 5, 2014

Related U.S. Application Data
(60) Provisional application No. 61/873,943, filed on Sep. 5, 2013.

(51) Int. Cl. G06Q 30/06; G07F 17/32; G06F 17/30

(52) U.S. Cl. CPC G06Q 30/0625; G06Q 30/0643; G06F 17/30864; G06F 17/30905; G07F 17/329
USPC 705/26.62

(57) ABSTRACT

In some embodiments, the instant invention provides for a method being implemented by an electronic search engine system, including the steps of: storing at least: visual presentations associated with a plurality of providers of products and/or services; and visual presentations of the products and/or the services; causing to concurrently display a first graphical user search interface to a plurality of users to allow each user to submit a search query; based on query data, searching for a subset of providers that offer product and/or service; where each visual presentations associated with each provider is configured to result in displaying the visual presentations of the product and/or the service, in response to a single action performed by such user; causing to display a second graphical user search interface to such user; where the second graphical user search interface displays the visual presentations associated with the subset of providers.

### RELATED APPLICATIONS

This application claims the priority of U.S. provisional application Ser. No. 61/873,943, entitled “SYSTEM AND METHOD FOR A 100% VISUAL SEARCH ENGINE TO INCREASE AND ACCELERATE THE VIEWERSHIP OF PRODUCTS AND SERVICES ONLINE,” filed on Sep. 5, 2013, which is hereby incorporated herein by reference in its entirety for all purposes.

### TECHNICAL FIELD

In some embodiments, the present invention relates to search for information on the Internet; specifically, electronic search engine with enhanced functionalities of generating visual-only product/service-relevant search results configured for delivery of product/service-relevant information upon selection thereof, and mobile smart devices and methods of utilizing thereof online.

### BACKGROUND

Typically, people type and/or speak key words into a search engine interface to find information on the Internet. Typically, the searching can be divided into an “organic” searching and a “non-organic” searching. Typically, the organic search result are search results that do not pertain to a paid advertiser listing. Typically, the non-organic search results are search results that pertain to a paid advertiser listing (e.g., a sponsored advertisement presented based on searched word(s)).

### SUMMARY OF INVENTION

In some embodiments, the instant invention provides for a computer-implemented method being implemented by an electronic search engine system programmed to perform in accordance with the computer-implemented method, including at least the following steps of: storing, by the electronic search engine system, in at least one database, at least the following: i) visual presentations associated with a plurality of providers of products, services, or both; ii) visual presentations of the products, the services, or both; and iii) information related to the products, the services, or both; causing, by the electronic search engine system, to concurrently display at least one first graphical user search interface to a plurality of users, connecting remotely over a network, where the at least one first graphical user interface is configured to allow each user to submit at least one search query to the electronic search engine; where the at least one search query being relates to at least one product, at least one service, or both; for each user: receiving, by the electronic search engine, query data representative of the at least one query, based on the query data, searching, by the electronic search engine system, the at least one database to identify a subset of providers from the plurality of providers that offer the at least one product, the at least one service, or both; where each visual presentations associated with each provider of the subset of providers is configured to result in displaying the visual presentations of the at least one product, the at least one service, or both, in response to a single action performed by such user; causing, by the electronic search engine system, to display at least one second graphical user search interface to such user; and where the at least one second graphical user search interface displays the visual presentations associated with the subset of providers.

In some embodiments, the visual presentations associated with the plurality of providers are images of logos of the plurality of providers.

In some embodiments, the method further includes generating, by the electronic search engine system, the images of logos of the plurality of providers based on the logos of the plurality of providers.

In some embodiments, the at least one second graphical user search interface is configured to display a predetermined number of the visual presentations within a visual displaying area.

In some embodiments, the method further includes the steps of: receiving, by the electronic search engine system, from the plurality of providers, a plurality of bids to advertise the products, service, or both; for each user: based on the plurality of bids, determining a presentation priority among the subset of providers; and where the at least one second graphical user search interface displays the visual presentations associated with the subset of providers in accordance with the presentation priority.

In some embodiments, an amount of each bid determines a positional location of particular visual presentation within the visual displaying area.

In some embodiments, the single action performed by such user is a clicking on a particular visual presentation associated with a particular provider.

In some embodiments, the plurality of providers are providers that pay to be included in the search.

In some embodiments, the method further includes at least the step of embedding, by the electronic search engine system, at least one hidden game in each visual presentation of the at least one product, the at least one service, or both.

In some embodiments, the at least one hidden game is an instant scratch-off game.

In some embodiments, the instant invention provides for an electronic search engine system that includes at least the following components: at least one specialized computing device, including: a non-transient memory having at least one region for storing particular computer executable program code; and at least one processor for executing the particular program code stored in the memory, where the particular program code is configured to at least perform the following operations upon the execution: storing, in at least one database, at least the following: i) visual presentations associated with a plurality of providers of products, services, or both; ii) visual presentations of the products, the services, or both; and iii) information related to the products, the services, or both; causing to concurrently display at least one first graphical user search interface to a plurality of users, connecting remotely over a network, where the at least one first graphical user interface is configured to allow each user to submit at least one search query to the electronic search engine; where the at least one search query being relates to at least one product, at least one service, or both; for each user: receiving query data representative of the at least one query, based on the query data, searching the at least one database to identify a subset of providers from the plurality of providers that offer the at least one product, the at least one service, or both; where each visual presentations associated with each provider of the subset of providers is configured to result in displaying the visual presentations of the at least one product, the at least one service, or both, in response to a single action performed by such user; causing to display at least one second graphical user search interface to such user; and where the at least one second graphical user search interface displays the visual presentations associated with the subset of providers.

### BRIEF DESCRIPTION OF THE DRAWINGS

The present invention will be further explained with reference to the attached figures.

FIGS. 1-4 are screenshots that illustrate certain aspects of some embodiments of the instant invention.

FIGS. 5-8 are screenshots illustrate certain aspects of some embodiments of the instant invention.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

### DETAILED DESCRIPTION

Among those benefits and improvements that have been disclosed, other objects and advantages of this invention can become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive. Any alterations and further modifications of the inventive feature illustrated herein, and any additional applications of the principles of the invention as illustrated herein, which can normally occur to one skilled in the relevant art and having possession of this disclosure, are to be considered within the scope of the invention.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

It is understood that at least one aspect/functionality of various embodiments described herein can be performed in real-time and/or dynamically. As used herein, the term “real-time” is directed to an event/action can occur instantaneously or almost instantaneously in time when another event/action has occurred. In some embodiments, the terms “instantaneous,” “instantaneously,” “instantly,” and “in real time” refer to a condition where a time difference between a first time when a search request is transmitted and a second time when a response to the request is received is no more than 1 second. In some embodiments, the time difference between the request and the response is between less than 1 second and several seconds. As used herein, the term “dynamic(ly)” is directed to an event/action that can occur without any human intervention. In some embodiments, the dynamic event/action may be in real-time.

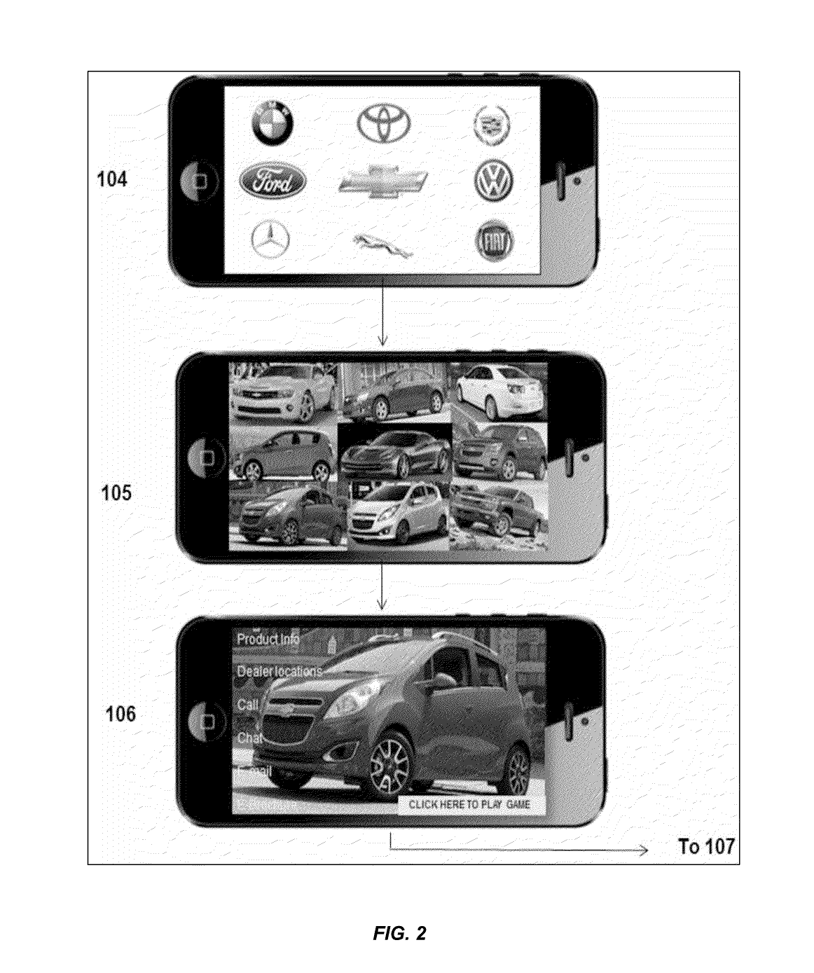

In some embodiments, as shown in FIG. 2, in response to a user submitting a search query, utilizing the computer device, the inventive electronic search engine in accordance with the instant invention cause a display 104 of a computer device (e.g., smartphone, tablet, etc.) to right away display visual-only product/service-relevant search results (e.g., car manufacturers' logos) that are generated by the inventive electronic search engine in accordance with the instant invention.

In some embodiments, the term “advertiser(s)” is directed to companies and/or individuals that offer products and/or services.

In some embodiments, as shown in FIG. 2, the inventive electronic search engine in accordance with the instant invention cause a display 105 of the computer device (e.g., smartphone, tablet, etc.) to right away display visual presentations (e.g., images, actionable thumbnails for playing video files, etc.) of a particular advertiser's products/services when the user selects (e.g., clicks on) visual-only product/service-relevant search results (e.g., the user selects/clicks on the Chevrolet logo, which causes the screen 105 to display images of Chevrolet vehicles).

In some embodiments, as shown in FIG. 2, when the user selects/clicks on a visual presentation for the advertiser's particular product/service on the display 105, the inventive electronic search engine in accordance with the instant invention cause a display 106 of the computer device (e.g., smartphone, tablet, etc.) to, for example, at least one of, but is not limited to: enlarge a particular visual presentation associated with the advertiser's particular product/service, display information about the advertiser's particular product/service (e.g., for car—to display technical, safety, performance, dealer locations, or other information), provide other actionable functionalities (e.g., but not limited to, chat, send and receive emails, play games, etc.), or any combination thereof.

In some embodiments, as shown in FIG. 2, the inventive electronic search engine in accordance with the instant invention cause a display 107 of the computer device (e.g., smartphone, tablet, etc.) to, for example, function as a game presentation such as, but is not limited to, an instant scratch off games being imbedded in the visual presentations of the advertiser's product(s)/service(s), allowing the user an opportunity to play and, optionally, win prize(s) as part of the search experience. In some embodiments, the user can, for example, digitally “scratch off” the visual presentation(s) of the advertiser's product(s)/service(s). In some embodiments, the event the user plays a game and wins a prize, the inventive electronic search engine in accordance with the instant invention can receive contact information (e.g., name, email address, etc.) of the user, utilizing any suitable functions (e.g., input functionalities by displaying a text box; data extracting functionalities by electronically obtaining the user's information from a third party's electronic source(s), etc.). In one example, for the user to collect prize(s), the inventive electronic search engine in accordance with the instant invention can transmit (e.g., emailed, displayed on a screen, etc.) winning code(s) to the user's smart device, which then can be, for example, shown to a salesperson at an advertiser's retail location(s) and/or electronically submitted to the advertiser's computer system (e.g., entering on a website).

In some embodiments, the inventive electronic search engine in accordance with the instant invention can operate on any programmable computer device such as smartphone, tablet, using a suitable mobile operating system (e.g., Android, iOS and Windows Phone, etc.).

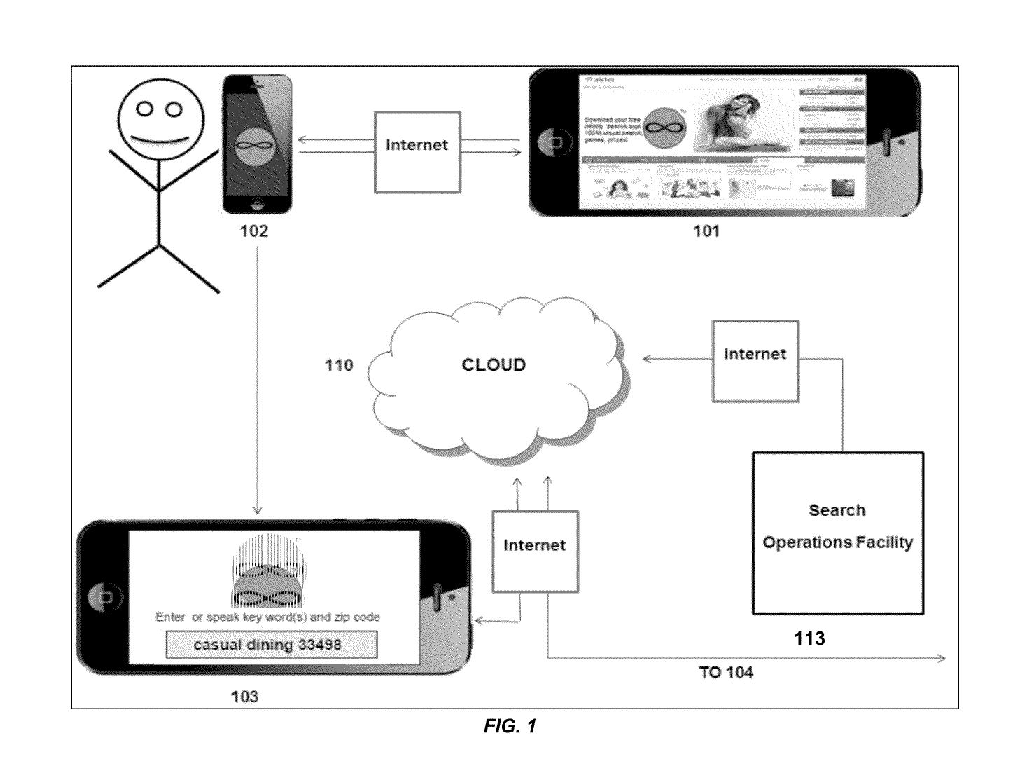

In some embodiments, as shown in FIG. 1, users can access, paid or unpaid, the inventive electronic search engine programmed in a form of mobile applications (Apps) (101, 102) by downloading them from websites, portals, and/or e-commerce sites. In some embodiments, the inventive electronic search engine programmed as Apps can be embedded in an operating system and/or web browsing/surfing applications of computer devices and can be invoked with a single action (e.g., speaks a question, types a query, makes a single click, etc.).

In some embodiments, as shown in FIG. 1, the inventive electronic search engine can be programmed to display a user graphical search interface (103). In some embodiments, the user can utilize user graphical search interfaces such as the user graphical search interface (103), to speak and/or enter key word(s) associated with and/or related to product(s) and/or service(s) and, optionally, a zip code. In some embodiments, the inventive electronic search engine with enhanced functionalities in accordance with the instant invention can automatically determine the user's geographic location (e.g., utilizing the device's IP address, GPS, etc.) and display the suggested geographic locality(ies) for limiting the search.

In some embodiments, as shown in FIG. 1, in response to the input of key word(s), the inventive electronic search engine instantly display visual presentation(s) of advertiser(s)' product(s)/service(s) (e.g., nine visual advertisement listings appear on the screen (104) in the form of advertiser logos). In some embodiments, as shown in FIG. 2, once the user clicks once on the advertiser logo of interest on the screen (104), the inventive electronic search engine instantly display on the display (105) visual presentations (e.g., images, actionable thumbnails for playing video files, etc.) for product(s)/service(s) of a particular advertiser.

In some embodiments, as shown in FIG. 2, for additional information on the product or service of interest, the user clicks on the visual presentation/image of interest. In some embodiments, the inventive electronic search engine in accordance with the instant invention then cause the visual presentation/image of interest to enlarge taking up the entire smart device display/screen (106). In some embodiments, as shown in FIG. 2, the inventive electronic search engine in accordance with the instant invention can cause to generate a user graphical interface display (107), being configured to enable the user to then access numerous details about the product or service from the enlarged image and, optionally, to digitally scratch off the image with a finger or mouse revealing potential prizes.

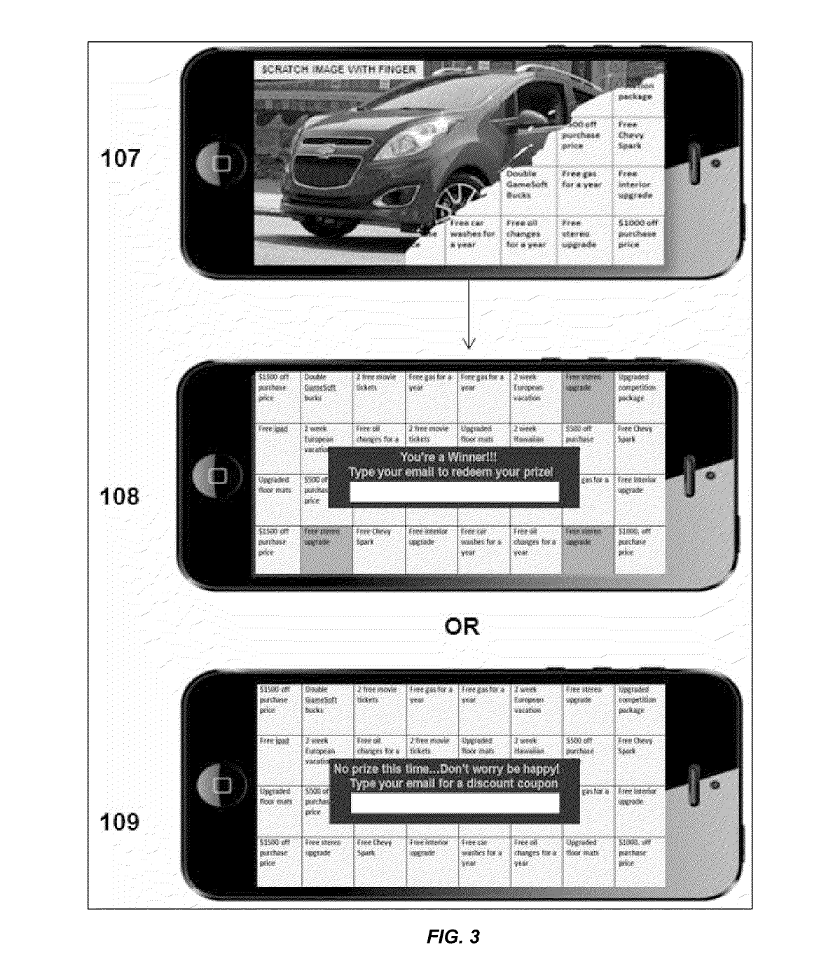

In some embodiments, as shown in FIG. 3, in the event the user wins, the inventive electronic search engine in accordance with the instant invention can cause to generate a user graphical interface display (108) which the user can use to enter his/her email address and, for example, can be provided with a code to claim their prize at the advertisers retail location and/or online. In some embodiments, as shown in FIG. 3, in the event the user doesn't win a prize, the inventive electronic search engine in accordance with the instant invention can cause to generate an electronic discount coupon after the user's, for example, email address is received utilizing a user graphical interface display (109).

In some embodiments, the inventive electronic search engine with enhanced functionalities generate one or more visual-only product/service-relevant search results configured for delivery of product/service-relevant information; and, thus, there are no text listings. In some embodiments, all visual advertisement listings generated by the inventive electronic search engine are non-organic (i.e., paid ad listings), and, thus, there are no organic (i.e., non-paid) listings. In some embodiments, the inventive electronic search engine with enhanced functionalities in accordance with the instant invention are solely designed for product and service search.

In some embodiments, as shown in FIG. 1, the inventive electronic search engine with enhanced functionalities in accordance with the instant invention utilize one or more databases residing in the Internet's “cloud” (110) (i.e., remotely locate from the user's computer device) and having advertiser(s)' visual presentations for theirs advertising listings and product and service information. In some embodiments, when a user speaks and/or enters keyword(s), the inventive electronic search engine with enhanced functionalities in accordance with the instant invention utilize communication functionalities (e.g., wireless transmission, etc.) of the user's smart device to connect the user to the inventive electronic search engine via the cloud. In some embodiments, the inventive electronic search engine with enhanced functionalities in accordance with the instant invention can utilize search operations server(s)/facility (113) to generate instant scratch off games imbedded and hidden in advertiser's product(s) and/or service-relevant visual presentations/images prior to placement of the visual ad listing in the cloud and being subsequently accessible by the user.

In some embodiments, the inventive electronic search engine with enhanced functionalities in accordance with the instant invention can utilize one or more databases in which visual ad listings and visual presentations of products and services that are segmented by market and/or industry. For example, if the user enters key words “new car” along with a zip code, the inventive electronic search engine with enhanced functionalities in accordance with the instant invention generate visual ad listings of advertisers in the industry servicing the user's zip code.

In some embodiments, the inventive electronic search engine with enhanced functionalities in accordance with the instant invention can generate the user graphical search interfaces that are segmented into a predetermined number of advertisement placement areas (i.e., only a predetermined number of advertisements are shown per screen). In some embodiments, the predetermined number of advertisement placement areas on a first page of search results is 9. In some embodiments, the predetermined number of advertisement placement areas is between 1 and 9, or up to 100.

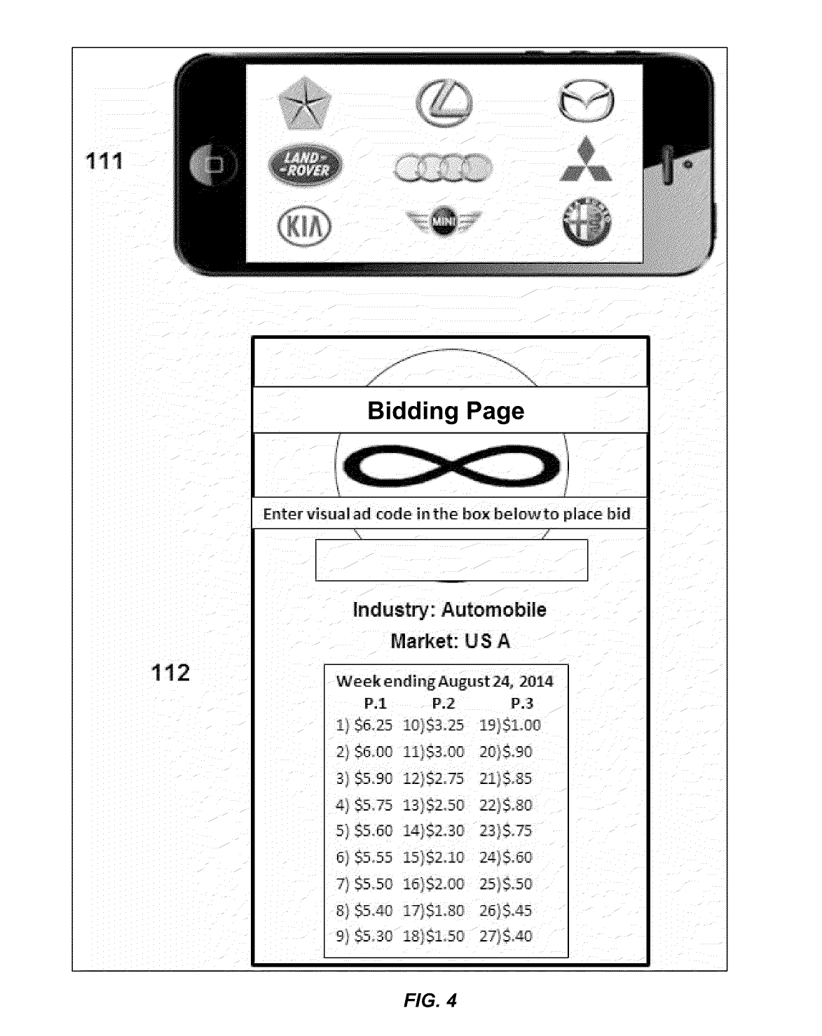

In some embodiments, the inventive electronic search engine with enhanced functionalities in accordance with the instant invention are configured to allow advertisers to bid against each other to attain their choice of a visual advertisement placement position on the 1st screen/display/page of the search results. In some embodiments, for example, as shown in FIG. 4, if there are nine advertisement placement areas per screen/display/page (111) of the search results, the inventive electronic search engine with enhanced functionalities in accordance with the instant invention will calculate first 9 highest advertisers based on bids submitted (112), and advertisements from advertisers whose bids are not one of the 9 highest bids are placed on subsequent pages. In some embodiments, the inventive electronic search engine with enhanced functionalities in accordance with the instant invention are configured to allow advertisers to periodically submit bids based on a predetermine time period which can be defined in seconds, minutes, hours, days, etc. (e.g., every 7 days). In some embodiments, the inventive electronic search engine with enhanced functionalities in accordance with the instant invention are configured to allow advertisers whose initial bids do not win the 1^{st} page placement spots (for example, in the above example, are at 10th place and lower) an opportunity to move their visual ad listing pages to the 1st page by placing a higher bid than their competitors.

In some embodiments, the inventive electronic search engine with enhanced functionalities in accordance with the instant invention generate a client code, enabling advertisers to access a list of bids (112) in real time to see, for example but not limited to, all bids in their industry and where their bid places them among their competitors. In some embodiments, the inventive electronic search engine with enhanced functionalities in accordance with the instant invention are configured to allow each advertiser to determine an amount they need to bid in order to outbid their competitors to secure a 1st page placement position.

In some embodiments, the inventive electronic search engine with enhanced functionalities in accordance with the instant invention are configured to accelerate the sale of products and services online using smart devices. In some embodiments, the inventive electronic search engine with enhanced functionalities in accordance with the instant invention are configured to enables users to instantly see a visual presentation/image of any product or service with one click. In some embodiments, the inventive electronic search engine with enhanced functionalities in accordance with the instant invention are configured to accelerate searching by utilizing visual-only ad listings/search results which appear as advertisers' logos on user graphical search interfaces. In some embodiments, one click on a logo and images of the advertiser's products or services are instantly displayed by the inventive electronic search engine with enhanced functionalities in accordance with the instant invention, allowing for increasing advertiser's odds of making a sale. In some embodiments, the inventive electronic search engine with enhanced functionalities in accordance with the instant invention generate visual ad listings which are not linked to an advertiser's website. In some embodiments, the inventive electronic search engine with enhanced functionalities in accordance with the instant invention generate visual presentations where every product or service image embeds/hides instant scratch off game(s), enabling the user, at his or her discretion, to play a game for a chance to win prizes and/or receive discount coupons.

In some embodiments, the inventive electronic search engine with enhanced functionalities in accordance with the instant invention are configured to concurrently/simultaneously interact with any number of users (e.g., 10 billion or more).

In some embodiments, the inventive electronic search engine with enhanced functionalities in accordance with the instant invention are configured to concurrently/simultaneously respond to any number of search requests (e.g., 10 billion or more).

In some embodiments, the inventive electronic search engine with enhanced functionalities in accordance with the instant invention are configured to concurrently/simultaneously interact with any number of advertisers (e.g., 1 billion or more).

Illustrative Operating Environments of Some Embodiments of the Instant Invention

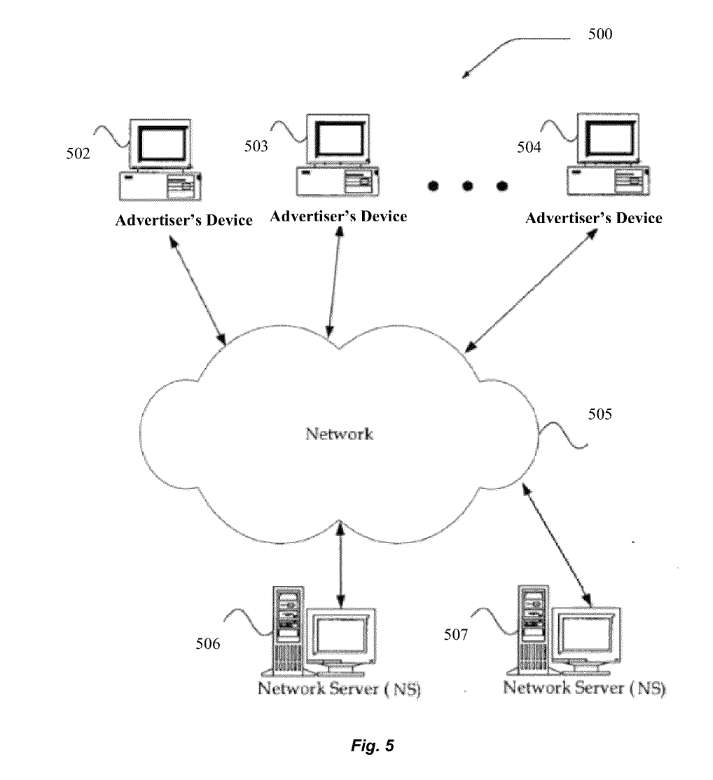

FIG. 5 illustrates one embodiment of an environment in which the present invention may operate. However, not all of these components may be required to practice the invention, and variations in the arrangement and type of the components may be made without departing from the spirit or scope of the invention. In other embodiments, the instant inventive systems are based on a scalable computer and network architecture that incorporates varies strategies for assessing the data, caching, searching, and database connection pooling. An example of the scalable architecture is an architecture that is capable of operating multiple servers.

In some embodiments, as shown in FIG. 5, advertisers access the inventive electronic search engine system, utilizing devices 502-504 that include virtually any computing device capable of receiving and sending a message over a network, such as network 505, to and from another computing device, such as servers 506 and 507 (e.g., servers supporting the inventive electronic search engine), each other, and the like. In some embodiments, the set of such devices includes devices that typically connect using a wired communications medium such as personal computers, multiprocessor systems, microprocessor-based or programmable consumer electronics, network PCs, and the like. In some embodiments, the set of such devices also includes devices that typically connect using a wireless communications medium such as cell phones, smart phones, pagers, walkie talkies, radio frequency (RF) devices, infrared (IR) devices, CBs, integrated devices combining one or more of the preceding devices, or virtually any mobile device, and the like. Similarly, in some embodiments, advertisers' devices 502-504 are any device that is capable of connecting using a wired or wireless communication medium such as a PDA, POCKET PC, wearable computer, and any other device that is equipped to communicate over a wired and/or wireless communication medium.

In some embodiments, each advertiser's device within advertisers' devices 502-504 may include a browser application that is configured to receive and to send web pages, and the like. In some embodiments, the browser application may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, JavaScript, and the like. In embodiments, the invention is programmed in either Java or .Net.

In some embodiments, advertisers' devices 502-504 may be further configured to receive a message from the another computing device employing another mechanism, including, but not limited to email, Short Message Service (SMS), Multimedia Message Service (MMS), instant messaging (IM), internet relay chat (IRC), mIRC, Jabber, and the like.

In some embodiments, network 505 may be configured to couple one computing device to another computing device to enable them to communicate. In some embodiments, network 505 may be enabled to employ any form of computer readable media for communicating information from one electronic device to another. Also, in some embodiments, network 505 may include a wireless interface, and/or a wired interface, such as the Internet, in addition to local area networks (LANs), wide area networks (WANs), direct connections, such as through a universal serial bus (USB) port, other forms of computer-readable media, or any combination thereof. In some embodiments, on an interconnected set of LANs, including those based on differing architectures and protocols, a router may act as a link between LANs, enabling messages to be sent from one to another.

Also, in some embodiments, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), fiber Optics links, wireless links including, but not limiting to, Bluetooth™ links, GPS, satellite links, or other communications links known to those skilled in the art. Furthermore, in some embodiments, remote computers and other related electronic devices could be remotely connected to either LANs or WANs via a modem and temporary telephone link. In essence, in some embodiments, network 505 includes any communication method by which information may travel between advertisers' devices 502-504, and servers 506 and 507.

In some embodiments, the terms “mobile electronic device” and “smart device” may refer to any portable electronic device that may or may not be enabled with location tracking functionality and utilizes Android, iOS, Windows Phone, or any other suitable mobile operating system. For example, a mobile electronic device can include, but is not limited to, a mobile phone, Personal Digital Assistant (PDA), Blackberry™, Pager, Smartphone, or any other reasonable mobile electronic device. For ease, at times the above variations are not listed or are only partially listed, this is in no way meant to be a limitation.

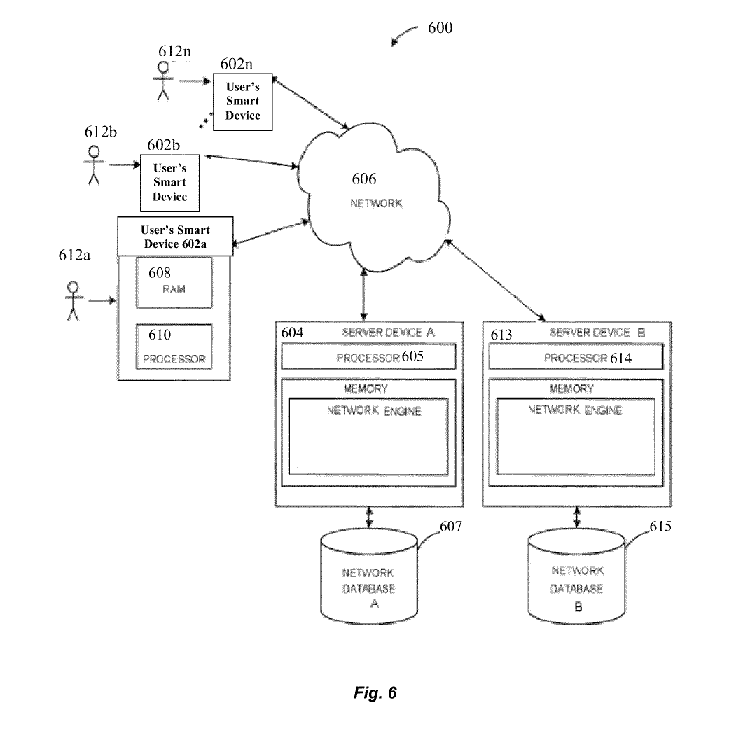

FIG. 6 shows another exemplary embodiment of the computer and network architecture that supports the inventive electronic search engine with enhanced functionalities in accordance with the instant invention. In some embodiments, the users' smart devices 602a, 602b thru 602n shown (e.g., users' mobile smart devices), each at least includes a computer-readable medium, such as a random access memory (RAM) 608 coupled to a processor 610 or FLASH memory. In some embodiments, the processor 610 may execute computer-executable program instructions stored in memory 608. In some embodiments, such processors comprise a microprocessor, an ASIC, and state machines. In some embodiments, such processors can comprise, or may be in communication with, media, for example computer-readable media, which stores instructions that, when executed by the processor, cause the processor to perform the steps described herein. In some embodiments, computer-readable media may include, but are not limited to, an electronic, optical, magnetic, or other storage or transmission device capable of providing a processor, such as the processor 610 of smart device 602a, with computer-readable instructions. Other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, JavaScript, or any other suitable computer language being suitable for Android, iOS, Windows Phone, or any other suitable mobile operating system. In some embodiments, users' devices 602a-n may also comprise a number of external or internal devices such as a mouse, a CD-ROM, DVD, a keyboard, a display, or other input or output devices.

In some embodiments, examples of users' smart devices 602a-n may be personal portable computers, digital assistants, personal digital assistants, cellular phones, mobile phones, smart phones, pagers, digital tablets, laptop computers, Internet appliances, and other processor-based devices. In general, a user's smart device 602a can be any type of processor-based platform that is connected to a network 606 and that interacts with one or more application programs. In some embodiments, users' smart devices 602a-n may operate on any operating system capable of supporting a browser or browser-enabled application, such as Microsoft™, Windows™, or Linux. In some embodiments, the users' smart devices 602a-n shown may include, for example, personal smartphones executing a browser application program such as Microsoft Corporation's Internet Explorer™, Apple Computer Inc.'s Safari™, Mozilla Firefox, Opera. And et. In some embodiments, through the users' smart devices 602a-n, users 61012a-n communicate over the network 606 with the inventive electronic search engine with enhanced functionalities in accordance with the instant invention and with other systems and devices coupled to the network 606 (e.g., databases with visual ad presentations/images). As shown in FIG. 6, server devices 604 and 613 may be also coupled to the network 606.

In some embodiments, the terms “proximity detection,” “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth™; GPS accessed using any reasonable form of wireless and/or non-wireless communication; WiFi™ server location data; Bluetooth™ based location data; triangulation such as, but not limited to, network based triangulation, WiFi™ server information based triangulation, Bluetooth™ server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

In some embodiments, the inventive electronic search engine with enhanced functionalities in accordance with the instant invention can utilize Near Field Technology (NFC) peer-to-peer communication to deliver content and/or distribute game information (e.g., prize code). In some embodiments, the NFC communications in accordance with the instant invention can utilize a plurality of NFC content a-enable devices within close proximity of each other. In some embodiments, NFC tags can contain data and be read-only or rewriteable. In some embodiment, NFC tags can be custom-encoded and utilize to provide or receive, for example, game codes. In some embodiments, NFC tags and/or NFC-enabled device (e.g., smart phones with NFC capabilities, either embedded or peripheral) can securely store personal data such as debit and credit card information, loyalty program data, PINS and networking contacts, among other information. In another embodiments, such personal data could be stored externally in a personal space on the Central Processor where excess could be granted to a specific client.

In some embodiments, vendor data may also be communicated using any wireless means of communication, such as 4G, 3G, GSM, GPRS, WiFi, WiMax, and other remote local or remote wireless communication using information obtained via the interfacing of the user's wireless NFC enabled mobile device to the vendor's NFC device. In some embodiments, the term “wireless communications” includes communications conducted at ISO 14443 and ISO 18092 interfaces. In some embodiments, the communications between users' NFC-enabled smart devices and vendor's equipment (e.g., terminals, POS, POE, Hosts) is performed, for example, in accordance with the ISO 14443A/B standard and/or the ISO 18092 standard.

In some embodiments, NFC-enabled devices could have NFC technology embedded in them or through attached peripherals, such as, but not limited to, NFC-enabled sim card, smartphone case, etc.

In some embodiments, user's NFC-enabled smart device may include a power source, an NFC circuit configured to wirelessly communicate using an NFC communications protocol, and a processor coupled to the power source and the NFC circuit. In some embodiments, the processor of user's NFC-enabled smart device may be configured to synchronize an internal timing signal to an external timing signal, cycle power to the NFC circuit to periodically switch the NFC circuit between a peer-to-peer recognition state and a low power state based upon the synchronized internal timing signal, and initiate peer-to-peer NFC communications with another NFC device when in range thereof and upon being simultaneously switched to the peer-to-peer recognition state therewith.

In some embodiments, user's NFC-enabled smart device may include a related physical computer-readable medium and may have computer-executable instructions for causing user's NFC-enabled smart device to initiating peer-to-peer NFC communications with another NFC device when in range thereof and upon being simultaneously switched to the peer-to-peer recognition state therewith.

In some embodiments, the processor of user's NFC-enabled smart device may be configured for communicating wireless voice and data via a cellular transceiver via a cellular communications network. By way of example, the data communications may include, but not limited to, email messages, Web data, etc.

In some embodiments, user's NFC-enabled smart device may in addition (or instead) include other types of wireless communications circuits capable of transmitting voice or other data, such as a wireless LAN, WiMAX, etc., circuit. In some embodiments, the processor of user's NFC-enabled smart device may proceed directly to communicate with the trusted NFC device, and in the case of a “smart poster” NFC device (e.g., SLP/SLS), such as one configured to pass a Uniform Resource Locator (URL), the processor may automatically direct a browser application thereof to the URL without prompting for permission to proceed to the designated location.

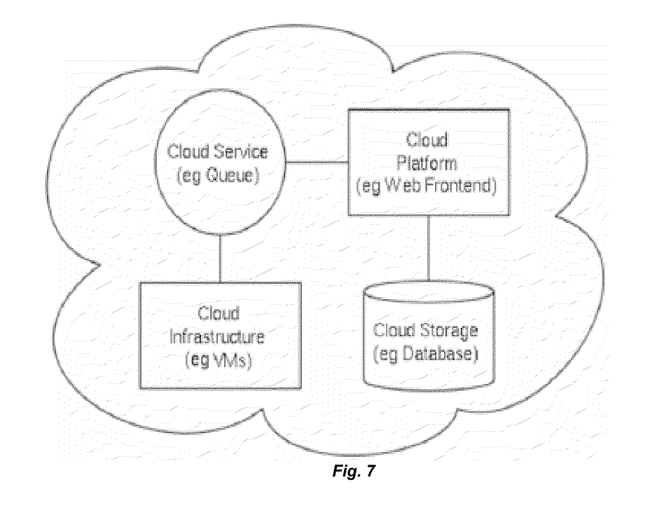

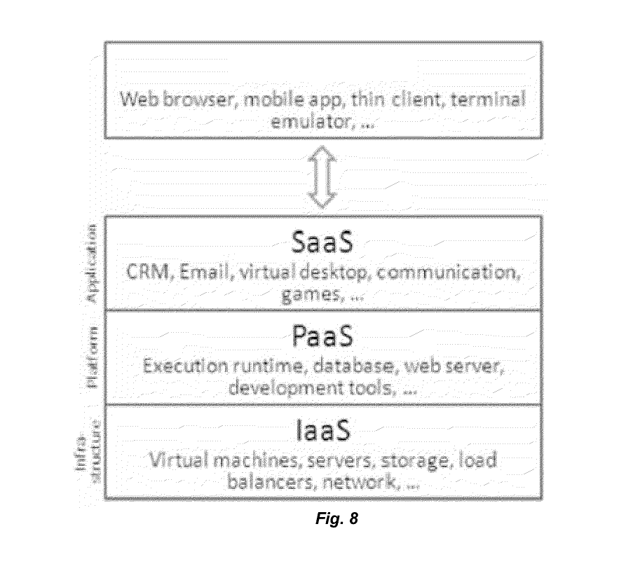

For purposes of the instant description, the terms “cloud,” “Internet cloud,” “cloud computing,” “cloud architecture,” and similar terms correspond to at least one of the following: (1) a large number of computers connected through a real-time communication network (e.g., Internet); (2) providing the ability to run a program or application on many connected computers (e.g., physical machines, virtual machines (VMs)) at the same time; (3) network-based services, which appear to be provided by real server hardware, and are in fact served up by virtual hardware (e.g., virtual servers), simulated by software running on one or more real machines (e.g., allowing to be moved around and scaled up (or down) on the fly without affecting the end user). In some embodiments, the instant invention offers/manages the cloud computing/architecture as, but not limiting to: infrastructure a service (IaaS), platform as a service (PaaS), and software as a service (SaaS). FIGS. 7 and 8 illustrate schematics of exemplary implementations of the cloud computing/architecture.

In some embodiments, the instant invention provides for a computer-implemented method being implemented by an electronic search engine system programmed to perform in accordance with the computer-implemented method, including at least the following steps of: storing, by the electronic search engine system, in at least one database, at least the following: i) visual presentations associated with a plurality of providers of products, services, or both; ii) visual presentations of the products, the services, or both; and iii) information related to the products, the services, or both; causing, by the electronic search engine system, to concurrently display at least one first graphical user search interface to a plurality of users, connecting remotely over a network, where the at least one first graphical user interface is configured to allow each user to submit at least one search query to the electronic search engine; where the at least one search query being relates to at least one product, at least one service, or both; for each user: receiving, by the electronic search engine, query data representative of the at least one query, based on the query data, searching, by the electronic search engine system, the at least one database to identify a subset of providers from the plurality of providers that offer the at least one product, the at least one service, or both; where each visual presentations associated with each provider of the subset of providers is configured to result in displaying the visual presentations of the at least one product, the at least one service, or both, in response to a single action performed by such user; causing, by the electronic search engine system, to display at least one second graphical user search interface to such user; and where the at least one second graphical user search interface displays the visual presentations associated with the subset of providers.

In some embodiments, the visual presentations associated with the plurality of providers are images of logos of the plurality of providers.

In some embodiments, the method further includes generating, by the electronic search engine system, the images of logos of the plurality of providers based on the logos of the plurality of providers.

In some embodiments, the at least one second graphical user search interface is configured to display a predetermined number of the visual presentations within a visual displaying area.

In some embodiments, the method further includes the steps of: receiving, by the electronic search engine system, from the plurality of providers, a plurality of bids to advertise the products, service, or both; for each user: based on the plurality of bids, determining a presentation priority among the subset of providers; and where the at least one second graphical user search interface displays the visual presentations associated with the subset of providers in accordance with the presentation priority.

In some embodiments, an amount of each bid determines a positional location of particular visual presentation within the visual displaying area.

In some embodiments, the single action performed by such user is a clicking on a particular visual presentation associated with a particular provider.

In some embodiments, the plurality of providers are providers that pay to be included in the search.

In some embodiments, the method further includes at least the step of embedding, by the electronic search engine system, at least one hidden game in each visual presentation of the at least one product, the at least one service, or both.

In some embodiments, the at least one hidden game is an instant scratch-off game.

In some embodiments, the instant invention provides for an electronic search engine system that includes at least the following components: at least one specialized computing device, including: a non-transient memory having at least one region for storing particular computer executable program code; and at least one processor for executing the particular program code stored in the memory, where the particular program code is configured to at least perform the following operations upon the execution: storing, in at least one database, at least the following: i) visual presentations associated with a plurality of providers of products, services, or both; ii) visual presentations of the products, the services, or both; and iii) information related to the products, the services, or both; causing to concurrently display at least one first graphical user search interface to a plurality of users, connecting remotely over a network, where the at least one first graphical user interface is configured to allow each user to submit at least one search query to the electronic search engine; where the at least one search query being relates to at least one product, at least one service, or both; for each user: receiving query data representative of the at least one query, based on the query data, searching the at least one database to identify a subset of providers from the plurality of providers that offer the at least one product, the at least one service, or both; where each visual presentations associated with each provider of the subset of providers is configured to result in displaying the visual presentations of the at least one product, the at least one service, or both, in response to a single action performed by such user; causing to display at least one second graphical user search interface to such user; and where the at least one second graphical user search interface displays the visual presentations associated with the subset of providers.

While a number of embodiments of the present invention have been described, it is understood that these embodiments are illustrative only, and not restrictive, and that many modifications may become apparent to those of ordinary skill in the art.

What is claimed is:

1. A computer-implemented method being implemented by an electronic search engine system programmed to perform in accordance with the computer-implemented method, comprising:
storing, by the electronic search engine system, in at least one database, at least the following:
i) visual presentations associated with a plurality of providers of products, services, or both;
ii) visual presentations of the products, the services, or both; and
iii) information related to the products, the services, or both;
causing, by the electronic search engine system, to concurrently display at least one first graphical user search interface to a plurality of users, connecting remotely over a network, wherein the at least one first graphical user interface is configured to allow each user to submit at least one search query to the electronic search engine; wherein the at least one search query being relates to at least one product, at least one service, or both;
for each user:
receiving, by the electronic search engine, query data representative of the at least one query,
based on the query data, searching, by the electronic search engine system, the at least one database to identify a subset of providers from the plurality of providers that offer the at least one product, the at least one service, or both;
wherein each visual presentations associated with each provider of the subset of providers is configured to result in displaying the visual presentations of the at least one product, the at least one service, or both, in response to a single action performed by such user;
causing, by the electronic search engine system, to display at least one second graphical user search interface to such user; and
wherein the at least one second graphical user search interface displays the visual presentations associated with the subset of providers.

2. The computer-implemented method of claim 1, wherein the visual presentations associated with the plurality of providers are images of logos of the plurality of providers.

3. The computer-implemented method of claim 2, wherein the method further comprises:
generating, by the electronic search engine system, the images of logos of the plurality of providers based on the logos of the plurality of providers.

4. The computer-implemented method of claim 1, wherein the at least one second graphical user search interface is configured to display a predetermined number of the visual presentations within a visual displaying area.

5. The computer-implemented method of claim 4, wherein the method further comprises:
receiving, by the electronic search engine system, from the plurality of providers, a plurality of bids to advertise the products, service, or both;
for each user:
based on the plurality of bids, determining a presentation priority among the subset of providers; and
wherein the at least one second graphical user search interface displays the visual presentations associated with the subset of providers in accordance with the presentation priority.

6. The computer-implemented method of claim 5, wherein an amount of each bid determines a positional location of particular visual presentation within the visual displaying area.

7. The computer-implemented method of claim 1, wherein the single action performed by such user is a clicking on a particular visual presentation associated with a particular provider.

8. The computer-implemented method of claim 1, wherein the plurality of providers are providers that pay to be included in the search.

9. The computer-implemented method of claim 1, wherein the method further comprises:
embedding, by the electronic search engine system, at least one hidden game in each visual presentation of the at least one product, the at least one service, or both.

10. The computer-implemented method of claim 9, wherein the at least one hidden game is an instant scratch-off game.

11. An electronic search engine system, comprising:
at least one specialized computing device, comprising:
a non-transient memory having at least one region for storing particular computer executable program code; and
at least one processor for executing the particular program code stored in the memory, wherein the particular program code is configured to at least perform the following operations upon the execution:
storing, in at least one database, at least the following:
i) visual presentations associated with a plurality of providers of products, services, or both;
ii) visual presentations of the products, the services, or both; and
iii) information related to the products, the services, or both;
causing to concurrently display at least one first graphical user search interface to a plurality of users, connecting remotely over a network, wherein the at least one first graphical user interface is configured to allow each user to submit at least one search query to the electronic search engine; wherein the at least one search query being relates to at least one product, at least one service, or both;
for each user:
receiving query data representative of the at least one query,
based on the query data, searching the at least one database to identify a subset of providers from the plurality of providers that offer the at least one product, the at least one service, or both;
wherein each visual presentations associated with each provider of the subset of providers is configured to result in displaying the visual presentations of the at least one product, the at least one service, or both, in response to a single action performed by such user;
causing to display at least one second graphical user search interface to such user; and
wherein the at least one second graphical user search interface displays the visual presentations associated with the subset of providers.

12. The electronic search engine system of claim 11, wherein the visual presentations associated with the plurality of providers are images of logos of the plurality of providers.

13. The electronic search engine system of claim 12, wherein the particular program code is further configured to further perform the following operations upon the execution:
generating the images of logos of the plurality of providers based on the logos of the plurality of providers.

14. The electronic search engine system of claim 11, wherein the at least one second graphical user search interface is configured to display a predetermined number of the visual presentations within a visual displaying area.

15. The electronic search engine system of claim 14, wherein the particular program code is further configured to further perform the following operations upon the execution:
receiving, from the plurality of providers, a plurality of bids to advertise the products, service, or both;
for each user:
based on the plurality of bids, determining a presentation priority among the subset of providers; and
wherein the at least one second graphical user search interface displays the visual presentations associated with the subset of providers in accordance with the presentation priority.

16. The electronic search engine system of claim 15, wherein an amount of each bid determines a positional location of particular visual presentation within the visual displaying area.

17. The electronic search engine system of claim 11, wherein the single action performed by such user is a clicking on a particular visual presentation associated with a particular provider.

18. The electronic search engine system of claim 11, wherein the plurality of providers are providers that pay to be included in the search.

19. The electronic search engine system of claim 11, wherein the particular program code is further configured to further perform the following operations upon the execution:
embedding at least one hidden game in each visual presentation of the at least one product, the at least one service, or both.

20. The electronic search engine system of claim 19, wherein the at least one hidden game is an instant scratch-off game.
